(19) United States
(12) Patent Application Publication
(10) Pub. No.: US 2008/0116146 A1
(43) Pub. Date: May 22, 2008

(54) WATER PURIFICATION SYSTEM

(75) Inventors: Rodney E. Herrington, Albuquerque, NM (US); Justin Sanchez, Albuquerque, NM (US)

Correspondence Address: PEACOCK MYERS, P.C., 201 THIRD STREET, N.W., SUITE 1340, ALBUQUERQUE, NM, 87102, US

(73) Assignee: MIOX Corproation, Albuquerque, NM (US)

(21) Appl. No.: 11/942,666

(22) Filed: Nov. 19, 2007

Related U.S. Application Data
(60) Provisional application No. 60/866,365, filed on Nov. 17, 2006.

(51) Int. Cl. C02F 1/461; B01D 65/00

(52) U.S. Cl. 210/748; 210/192

(57) ABSTRACT

An electrolytic device and method for generating a disinfecting solution is powered by a circuit preferably comprising a voltage adjustment circuit and rechargeable battery that can be recharged by a variety of devices including a solar panel. The disinfectant device can be utilized with a water filter and a storage device such as a carafe to produce potable water meeting drinking water requirements.

### CROSS-REFERENCE TO RELATED APPLICATIONS

This application claims priority to and the benefit of filing of U.S. Provisional Patent Application Ser. No. 60/866,365, entitled “Water Purification System”, filed on Nov. 17, 2006, the specification of which is incorporated herein by reference.

### BACKGROUND OF THE INVENTION

1. Field of the Invention (Technical Field)

The present invention relates to a water treatment system that preferably comprises a water storage container, a filtration mechanism, and an electrolytic disinfectant generator with an electrical circuit and energy storage device to produce safe drinking water from raw water.

2. Background Art

Note that the following discussion refers to a number of publications and references. Discussion of such publications herein is given for more complete background of the scientific principles and is not to be construed as an admission that such publications are prior art for patentability determination purposes.

Electrolytic technology utilizing dimensionally stable anodes (DSA) has been used for years for the production of chlorine and other mixed-oxidant solutions. Dimensionally stable anodes are described in U.S. Pat. No. 3,234,110 to Beer, entitled “Electrode and Method of Making Same,” whereby a noble metal coating is applied over a titanium substrate.

An example of an electrolytic cell with membranes is described in U.S. Pat. RE 32,077 to deNora, et al., entitled “Electrode Cell with Membrane and Method for Making Same,” whereby a circular dimensionally stable anode is utilized with a membrane wrapped around the anode, and a cathode concentrically located around the anode/membrane assembly.

An electrolytic cell with dimensionally stable anodes without membranes is described in U.S. Pat. No. 4,761,208 to Gram, et al., entitled “Electrolytic Method and Cell for Sterilizing Water.”

Various commercial electrolytic cells that have been used routinely for oxidant production may utilize a flow-through configuration that may or may not be under pressure that is adequate to create flow through the electrolytic device. Examples of cells of this configuration are described in U.S. Pat. No. 6,309,523 to Prasnikar, et al., entitled “Electrode and Electrolytic Cell Containing Same,” and U.S. Pat. No. 5,385,711 to Baker, et al., entitled “Electrolytic Cell for Generating Sterilization Solutions Having Increased Ozone Content,” and many other membrane-type cells.

In other configurations, the oxidant is produced in an open-type cell or drawn into the cell with a syringe or pump-type device, such as described in U.S. Pat. No. 6,524,475 to Herrington, et al., entitled “Portable Water Disinfection System.”

U.S. Pat. No. 6,736,966 to Herrington, et al., entitled “Portable Water Disinfection System”, the specification and claims of which is incorporated herein by reference, describes disinfection devices that utilize, in one instance, a cell chamber whereby hydrogen gas is generated during electrolysis of an electrolyte, and provides the driving force to expel oxidant from the cell chamber through restrictive check valve type devices. In this configuration, unconverted electrolyte is also expelled from the body of the cell as hydrogen gas is generated. In an alternate configuration in the same application, hydrogen gas pressure is contained in a cell chamber during electrolysis, but the pressure within the cell chamber is limited by the action of a spring loaded piston that continues to increase the volume of the cell chamber as gas volume increases. Ultimately, a valve mechanism opens, and the spring-loaded piston fills the complete volume of the cell chamber forcing the oxidant out of the cell chamber.

In the electrolytic cells utilizing titanium substrates with noble metal coatings as the anode, the pH at the surface of the anode is typically low, on the order of approximately 3. With sufficiently high brine concentration in the electrolyte, and sufficiently low voltage potential at the anode surface, oxygen generated at the anode surface reacts to form hypochlorous acid and other chlor-oxygen compounds with no oxygen gas liberated.

Typical cathodes in these electrolytic cells may be composed of titanium, noble metal coated titanium, catalyst coated titanium, nickel based alloys such as Hastalloy, stainless steel, and other conductive materials impervious to high pH conditions. Hydrogen is typically liberated at the cathode surface with a localized high pH value at the cathode surface. During electrolysis, the metal comprising the cathode is not oxidized or otherwise damaged during electrolysis despite the production of hydrogen at the cathode surface. Over time, titanium hydride can form at the surface of a bare titanium cathode which may cause stress concentrations in the cathode surface. To preclude this hydride formation, noble metal or catalyst coatings can be applied to the cathode surface.

U.S. Pat. No. 7,015,654 to Kuhlmann, et al, describes a power conditioning circuit. A microcontroller and boost converter circuit provide constant current to a light emitting diode array or other energy consuming source such as an electrolytic cell. A micro-controller operatively coupled with a semiconductor switch and the boost converter circuit measure the ability of a DC power supply to change the inductor. Duty cycles of the semiconductor switch are modified according to the measurement so as to supply substantially constant current to the LED array or electrolytic cell through an inductor regardless of actual battery voltage.

### SUMMARY OF THE INVENTION (DISCLOSURE OF THE INVENTION)

The present invention is a portable water treatment device comprising a first reservoir for receiving untreated water, an electrolytic cell for producing a disinfectant, a power source, a second reservoir for storing treated water, and a filter disposed between the first reservoir and the second reservoir. The device preferably comprises a carafe or pitcher. The power source preferably comprises a solar cell and/or a rechargeable battery. The filter is optionally integrated into a handle for holding the device. The filter optionally attaches to the first reservoir and the second reservoir via quick connect type couplings. The filter is preferably cleanable and/or replaceable. The device is preferably configured to dispense treated water.

The present invention is also a water treatment device comprising a single reservoir, an electrolytic cell for producing a disinfectant, a power source, a filter, and a dispenser. The reservoir preferably holds water before and after the water is treated with the disinfectant. The power source preferably comprises a solar cell and/or a rechargeable battery. Treated and filtered water is preferably discharged from the dispenser via gravity flow.

The present invention is also a water treatment device comprising a stand comprising a reservoir for receiving untreated water, a filter, an electrolytic cell for producing a disinfectant, the electrolytic cell configured to provide the disinfectant into filtered water flowing over the electrolytic cell, a power source, and a portable container for storing treated water, the container comprising an opening for receiving filtered water and disinfectant from the stand. The device preferably further comprises a pump for pumping untreated water through the filter to the electrolytic cell. The container preferably comprises a carafe or pitcher.

The present invention is also a method for treating water, the method comprising the steps of receiving untreated water into a first reservoir, filtering the water, electrolytically producing a disinfectant, introducing the disinfectant into the filtered or unfiltered water, disinfecting the water with the disinfectant, storing the filtered and disinfected water in a second reservoir, and dispensing the filtered and disinfected water. The method preferably further comprises transporting the second reservoir to a desired location prior to the dispensing step. The second reservoir optionally comprises a carafe or pitcher, or the first reservoir and second reservoir are preferably integrated into a carafe or pitcher. The method preferably further comprises powering a rechargeable battery for powering the step of electrolytically producing a disinfectant. The method preferably further comprises the step of recharging the battery using one or more solar cells. The filtering step preferably comprises pumping untreated water through a filter. The introducing step preferably comprises introducing the disinfectant into filtered water flowing over an electrolytic cell. The method preferably further comprises the step of cleaning or replacing the filter. The method preferably further comprises the step of releasing hydrogen gas from the second reservoir. The method preferably further comprises the step of forming a brine solution by introducing a predetermined amount of filtered water into an electrolytic cell comprising a salt.

The present invention preferably comprises a water container that incorporates an electrolytic disinfection device and water filtration device. In one embodiment, the water storage container is preferably separated in to two parts, the first part being a storage area for untreated water, and the second part being a storage area for treated water. The separation between the two storage areas preferably comprises a filter device, preferably a ceramic filter. The electrolytic disinfection device preferably utilizes sodium chloride as a salt that is converted to brine and is electrolyzed to form sodium hypochlorite and/or mixed oxidants (preferably chlorine based) as the disinfectant. The circuit to power the electrolytic cell preferably comprises a rechargeable battery and an electric circuit to generate a pulsed direct current voltage of sufficient potential to generate a mixed oxidant solution. The rechargeable battery is optionally recharged using a solar panel. The disinfectant solution is preferably introduced to the filtered water compartment of the water storage device. The disinfectant may alternatively first be introduced into the raw water compartment to disinfect the water prior to filtration.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a system view of an embodiment of the present invention in which the fluid to be treated is filtered and disinfected with mixed oxidants produced from a solar powered electrolytic cell on the top of the fluid storage container.

FIG. 2 is a system view of an embodiment of the present invention in which the fluid to be treated is filtered by a replaceable filter element, and disinfected with mixed oxidants produced from a solar powered electrolytic cell on the top of the fluid storage container.

FIG. 3 is a view of an embodiment of the present invention in which the fluid to be treated is collected in a container with a disinfection device mounted on the top of the container, and a filter is in-line with the drain connection from the storage container.

FIG. 4 is a view of an embodiment of the present invention in which the fluid to be treated is collected in one compartment and is transferred to an electrolytic cell where disinfectant is produced; the fluid purges the disinfectant from the cell and the fluid and disinfectant are transferred to a fluid storage container.

### DESCRIPTION OF THE PREFERRED EMBODIMENTS

### BEST MODES FOR CARRYING OUT THE INVENTION

The present invention preferably comprises an electrolytic device powered by a rechargeable battery used to provide disinfectant solution to water stored in a container which preferably comprises a filter device to remove contaminants from the water.

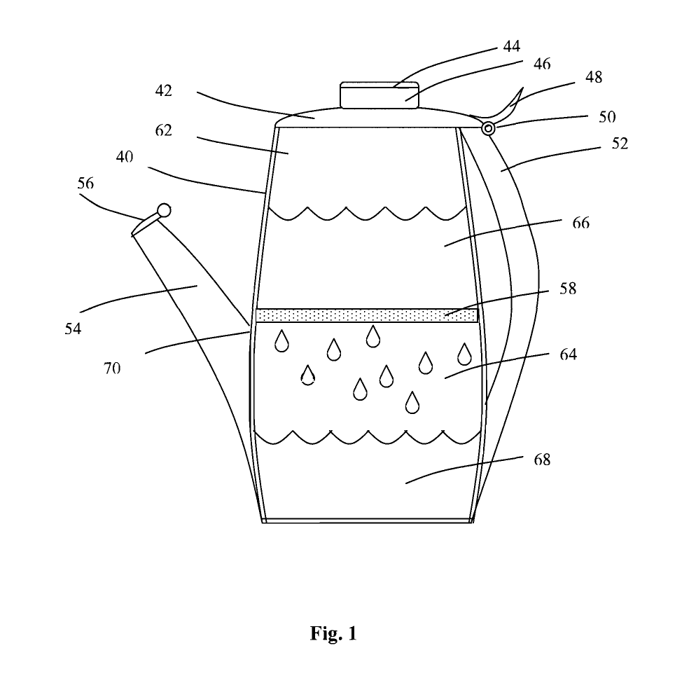

In the embodiment of the present invention shown in FIG. 1, water carafe 40 preferably comprises upper compartment 62, lower compartment 64, cover 42, disinfectant device 46, handle 52, filter 58, which may comprise a ceramic filter such as a ceramic disc, and spout 54. Disinfectant device 46 preferably comprises an electrolytic cell for converting sodium chloride salt (or other suitable halogen salt) to brine and electrolyzes it to produce a sodium hypochlorite or chlorine based mixed oxidant solution. Disinfectant device 46 optionally comprises solar panel 44 to recharge an energy storage device such as a battery, and utilizes an electrical circuit to condition power to the appropriate electrical characteristics to maximize inactivation of microorganisms in the electrolytic cell. In operation, the user preferably opens empty carafe 40 by pivoting cover 42 about hinge 50 by pressing on lever 48. Any type of cover may alternatively be used. Un-purified or dirty water 66 is placed in upper container 62. Unpurified water 66 passes through filter 58, which removes dirt and other particulate matter, and enters lower container 64 as filtered water 68.

In another embodiment of the device, disinfectant device 46 is powered by a cord which plugs into a standard power distribution system, or by other means.

Disinfectant solution is generated electrolytically in disinfectant device 46 and preferably passes down a hollow passage within handle 52 to disinfect filtered water 68, thereby ensuring all microorganisms (e.g. viruses, bacteria, protozoan cysts, etc.) are chemically inactivated. Purified and filtered water 68 can now be poured out of carafe 40 via spout 54 through optional hinged cover 56. During any electrolysis process, hydrogen gas is generated at the cathode surface. Carafe 40 is preferably configured such that upper neck 70 of spout 54 is located in proximity to the upper area of lower container 64. This configuration preferably allows any hydrogen gas generated in the electrolysis process that enters lower container 64 to exit carafe 40 via spout 54 through loose fitting hinged cover 56. Filter 58 may optionally comprise multi-layers of ceramic, which may optionally be replaced or supplemented by another type of filter media, including but not limited to activated carbon, charcoal, membrane sheets, ion exchange resins, or any particulate filtration media. Carafe 40 may optionally be configured so that the filter is replaceable, for example through a slot in the exterior of carafe 40.

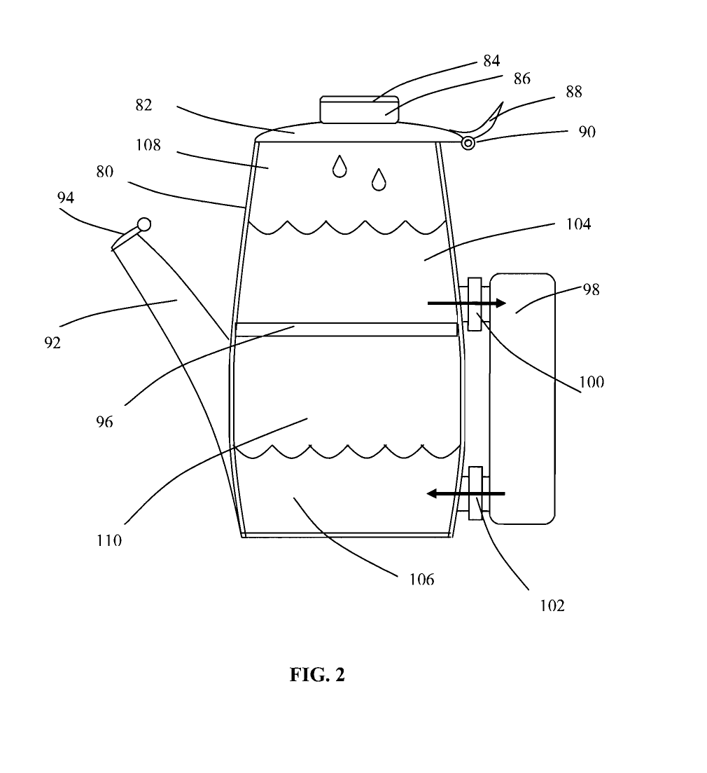

In the embodiment of the present invention shown in FIG. 2, water carafe 80 preferably comprises upper compartment 108, lower compartment 110, cover 82, disinfectant device 86, filter 98, liquid barrier 96, and spout 92. Disinfectant device 86 is optionally powered by solar panel 84. In operation, the user preferably opens the empty carafe 80 by pivoting cover 82 about hinge 90 by pressing on lever 88. Un-purified or dirty water 104 is placed in upper container 108. Un-purified water 104 passes through filter 98, which preferably removes dirt and other particulate matter and optionally also comprises the handle of carafe 80, and enters lower container 110. Disinfectant solution is generated electrolytically in disinfectant device 86 and preferably drips down into dirty water 104 as the water seeps through filter 98. Filter 98 is preferably attached to carafe 80 via quick disconnect passages 100,102 which provide a quick and simple method for replacement of filter 98. Filter 98 may comprise hollow fiber membranes, ion exchange resin, activated carbon, or other filtration media suitable to remove a variety of contaminants and/or particulates in raw or untreated water. To keep other contaminants out of filtered water 106, spout 92 preferably comprises flapper lid 94.

The disinfectant generated by disinfection device 86 may alternatively be introduced to the water after the water has passed through filter 98. In this configuration disinfection device 86 may optionally be located in the handle of carafe 80.

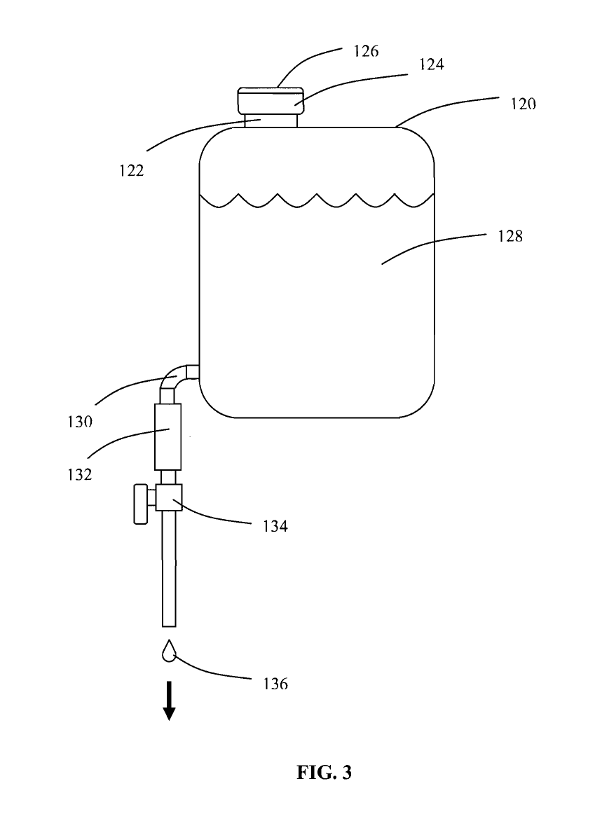

In the embodiment of the present invention shown in FIG. 3, raw water 128 is placed in water storage container 120, preferably by removing disinfection device 124 and pouring water through opening 122. Disinfection device 124 may be attached to water storage container 120 by threads, snaps, or other suitable means for placing a cap on a container. Disinfection device 124 preferably comprises a rechargeable battery, which is preferably charged via solar panel 126. On activation of disinfection device 124, a salt water brine solution is preferably electrolytically converted to a sodium hypochlorite or mixed oxidant solution. The disinfectant solution preferably drips from disinfection device 124 into raw water 128, thereby disinfecting raw water 128. The user preferably withdraws water from water storage container 120 by opening valve 134. As the disinfected water passes through discharge port 130 of water storage container 120, the water preferably passes through filter 132. Filter 132 may comprise hollow fiber membranes, ion exchange resin, activated carbon, or other filtration media suitable to remove a variety of contaminants and/or particulates in raw or untreated water. Potable water 136 is then suitable for human consumption.

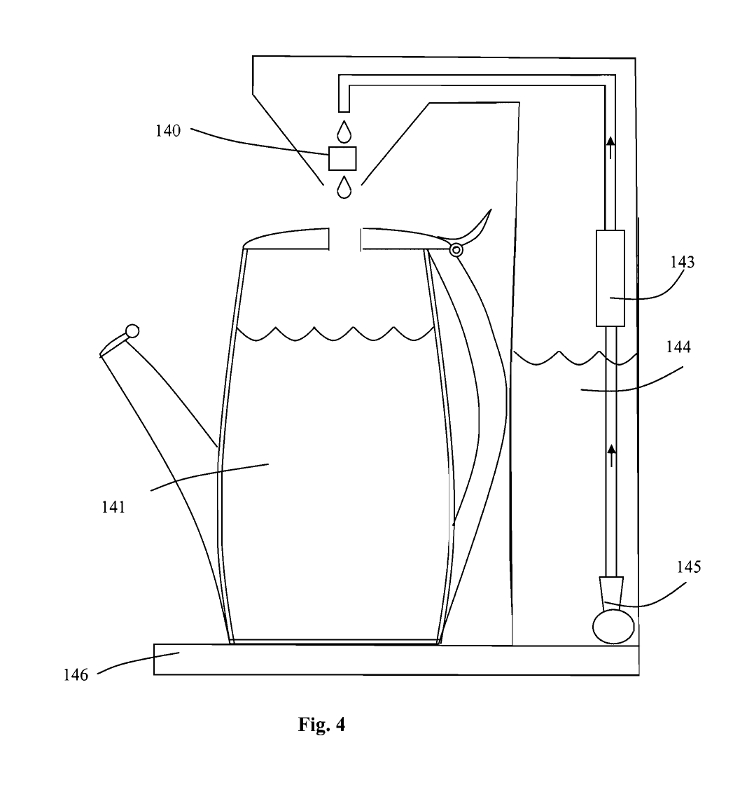

Another embodiment of the present invention is shown in FIG. 4. Raw water is placed in raw water storage compartment 144 which is preferably integrated with carafe stand 146. Electrolytic cell 140 is preferably loaded with brine solution (either automatically or manually), or alternatively with dry sodium chloride or another suitable halogen either manually or via an automated system. Internal pump 145 is activated momentarily to add sufficient water to electrolytic cell 140. Internal controls then preferably supply direct current to electrolytic cell 140, thereby creating a concentrated disinfection solution. Internal pump 145 is preferably subsequently activated, forcing raw water through filter 143. After passing through the filter, the water preferably cascades over electrolytic cell 140 and flows into second storage reservoir 141. In this way, the disinfectant is carried into second storage reservoir 141 where it disinfects the water, which can then be used for consumption. Second storage reservoir 141 preferably comprises a portable container, such as a carafe or pitcher, but may optionally comprise any form factor.

Internal pump 145 may not be required if the raw water storage compartment is situated above second storage reservoir 141, as long as a solenoid or similar device is used to regulate flow out of the raw water storage compartment. In an alternative embodiment of the present invention, internal pump 145 is a mechanical pump activated manually or by some other motive means. Electrical power can be supplied by a solar panel, chemical storage device (battery), manually operated electrical generator, or by a conventional electrical power outlet.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A portable water treatment device comprising:
a first reservoir for receiving untreated water;
an electrolytic cell for producing a disinfectant;
a power source;
a second reservoir for storing treated water; and
a filter disposed between said first reservoir and said second reservoir.

2. The portable water treatment device of claim 1 comprising a carafe or pitcher.

3. The portable water treatment device of claim 1 wherein said power source comprises a solar cell and/or a rechargeable battery.

4. The portable water treatment device of claim 1 wherein said filter is integrated into a handle for holding said device.

5. The portable water treatment device of claim 1 wherein said filter attaches to said first reservoir and said second reservoir via quick connect type couplings.

6. The portable water treatment device of claim 1 wherein said filter is cleanable and/or replaceable.

7. The portable water treatment device of claim 1 configured to dispense treated water.

8. A water treatment device comprising:
a single reservoir;
an electrolytic cell for producing a disinfectant;
a power source;
a filter; and
a dispenser.

9. The water treatment device of claim 8 wherein said reservoir holds water before and after the water is treated with the disinfectant.

10. The water treatment device of claim 8 wherein said power source comprises a solar cell and/or a rechargeable battery.

11. The water treatment device of claim 8 wherein treated and filtered water is discharged from said dispenser via gravity flow.

12. A water treatment device comprising:
a stand comprising a reservoir for receiving untreated water;
a filter;
an electrolytic cell for producing a disinfectant, said electrolytic cell configured to provide the disinfectant into filtered water flowing over said electrolytic cell;
a power source; and
a portable container for storing treated water, said container comprising an opening for receiving filtered water and disinfectant from said stand.

13. The water treatment device of claim 12 further comprising a pump for pumping untreated water through said filter to said electrolytic cell.

14. The water treatment device of claim 12 wherein said container comprises a carafe or pitcher.

15. A method for treating water, the method comprising the steps of:
receiving untreated water into a first reservoir;
filtering the water;
electrolytically producing a disinfectant;
introducing the disinfectant into the filtered or unfiltered water;
disinfecting the water with the disinfectant;
storing the filtered and disinfected water in a second reservoir; and
dispensing the filtered and disinfected water.

16. The method of claim 15 further comprising transporting the second reservoir to a desired location prior to the dispensing step.

17. The method of claim 16 wherein the second reservoir comprises a carafe or pitcher.

18. The method of claim 16 wherein the first reservoir and second reservoir are integrated into a carafe or pitcher.

19. The method of claim 15 further comprising powering a rechargeable battery for powering the step of electrolytically producing a disinfectant.

20. The method of claim 19 further comprising the step of recharging the battery using one or more solar cells.

21. The method of claim 15 wherein the filtering step comprises pumping untreated water through a filter.

22. The method of claim 15 wherein the introducing step comprises introducing the disinfectant into filtered water flowing over an electrolytic cell.

23. The method of claim 15 further comprising the step of cleaning or replacing the filter.

24. The method of claim 15 further comprising the step of releasing hydrogen gas from the second reservoir.

25. The method of claim 15 further comprising the step of forming a brine solution by introducing a predetermined amount of filtered water into an electrolytic cell comprising a salt.
